(19) United States
(12) Patent Application Publication
(10) Pub. No.: US 2023/0385065 A1
(43) Pub. Date: Nov. 30, 2023

(54) Apparatus and Method for Simultaneous Multithreaded Instruction Scheduling in a Microprocessor

(71) Applicant: Telefonaktiebolaget LM Ericsson (publ), Stockholm (SE)

(72) Inventors: Mehdi Alipour, Limhamn (SE); Fredrik Dahlgren, Lund (SE)

(21) Appl. No.: 18/031,070

(22) PCT Filed: Oct. 14, 2020
(86) PCT No.: PCT/EP2020/078965

§ 371 Date: Apr. 10, 2023

(51) Int. Cl. G06F 9/38; G06F 9/48

(52) U.S. Cl. CPC G06F 9/3836; G06F 9/4881; G06F 9/3867

(57) ABSTRACT

Techniques disclosed herein provide, among other things, advantageous mechanisms for detecting and resolving resource monopolization by one or more “slower” instruction threads in an instruction pipeline of a microprocessor that supports Simultaneous Multi-Threading (SMT). One or more embodiments involve updating thread rankings, e.g., from slowest to fastest, on an instruction cycle basis, and redirecting instructions from at least a slowest one of the threads, to bypass one or more shared resources that would otherwise be monopolized by instructions in the slower/slowest threads. In at least one embodiment, bypassing includes redirecting selected instructions away from more critical shared resources to lower-cost or lower-power secondary resources, for example bypassing an instruction queue in favor of a less complex buffer circuit.

### TECHNICAL FIELD

Methods and apparatus disclosed herein relate to microprocessor circuits, specifically multithreaded pipeline circuits and simultaneous multithreaded instruction scheduling.

### BACKGROUND

Modern microprocessors exploit various techniques to improve performance by increasing on-chip parallelism. Executing multiple instructions at the same time represents an example of parallelism having nearly universal application. Processors capable of executing multiple instructions at the same time are called superscalar. Superscalar processors execute multiple instructions in-order or out-of-order in correlation with the program order, where the term “program order” is the sequential order defined by the program according to some semantics and the involved programming model.

An in-order superscalar processor executes multiple adjacent instructions at the same time, while an out-of-order superscalar processor also finds and executes multiple instructions at the same time, but the instructions do not have to be adjacent. The out-of-order processor operates on a “dynamic instruction window” that spans a meaningful number of program instructions. The out-of-order processor finds and executes a few independent instructions currently within the dynamic instruction window at the same time to improve Instructions Level Parallelism (ILP).

The number of independent instructions included at any given time in the dynamic window limits the parallelism that an out-of-order processor can exploit. Some programs have more intrinsic ILP, and some have less. The lack of ILP in a program leads to hardware underutilization. For example, fewer independent instructions limit the ability of schedulers to dispatch instructions for execution and cache misses and branch mispredictions may result in relatively long “stalls” that affect the entire processor for multiple cycles.

Simultaneous Multithreading (SMT) addresses the problem of hardware underutilization by executing multiple instructions not only at the same time but also from independent program threads within one or more programs. In SMT, multiple instruction threads use the same hardware and share it either statically or dynamically. As a result of sharing, when one of the threads does not have enough ILP to utilize the hardware, the other threads act as a backup to provide adequate ILP thorough thread-level parallelism (TLP).

Static sharing in the SMT context dedicates private access to the involved hardware to each of the threads. Static sharing offers implementation simplicity and correspondingly lower hardware overhead but its use is limited to no more than a few threads and it is not extendable.

Dynamic sharing aims for maximizing resource utilization and, accordingly, performance and system throughout. Dynamic resource sharing for SMT microprocessors assumes that threads will share the resource equally. Inevitably, however, some instruction threads occupy the shared resources more than their “fair share,” which can lead to a problem called “resource monopoly.” When one of the instruction threads sharing resources with other threads has insufficient ILP or experiences a long latency instruction, it may prevent the other threads from using the shared hardware resources. Resource monopoly within an SMT processor reduces both single-threaded performance and overall throughput.

Instruction scheduling consumes a significant amount of the total energy of a SMT processor. Resource monopoly aggravates this situation. For example, the circuitry comprising the instruction pipeline of a microprocessor may include one or more “instruction queues” or other complex buffering structures used to hold instructions pending for execution. Because of the connectivity required for scheduling instructions and dispatching those ready for execution, instruction queues are relatively expensive in terms of physical size and corresponding power consumption.

Monopolization of such circuitry by given instruction threads in an SMT context may significantly reduce overall throughput and efficiency of the instruction pipeline and there are known approaches intended to address the monopolization problem, at least partially. However, the existent solutions tend to involve costly circuit structures and commonly operate on a reactive basis with corresponding delays in relieving monopolization problems rather than avoiding them. Further, known approaches do nothing to relax design requirements on the instruction queue and generally address only one problematic thread at a time, among the multiple instruction threads being pipelined for simultaneous scheduling, dispatching, and execution.

### SUMMARY

Techniques disclosed provide, among other things, advantageous mechanisms for detecting and resolving resource monopolization by one or more “slower” instruction threads in an instruction pipeline of a microprocessor that supports Simultaneous Multi-Threading (SMT). One or more embodiments involve updating thread rankings, e.g., from slowest to fastest, on an instruction cycle basis, and redirecting instructions from at least a slowest one of the threads, to bypass one or more shared resources that would otherwise be monopolized by instructions in the slower/slowest threads. In at least one embodiment, bypassing includes redirecting selected instructions away from more critical shared resources to lower-cost or lower-power secondary resources, for example bypassing an instruction queue in favor of a less complex buffer circuit. In an example embodiment, a microprocessor comprises a multithreaded pipeline circuit, with the multithreaded pipeline circuit (MPC) comprising a dispatch circuit configured to dispatch instructions from two or more parallel instruction threads in program order, towards a reservation queue of the MPC that is used to queue dispatched instructions for issuance to a functional circuit according to an out-of-order issuance scheduling. Further, the MPC comprises a control circuit included in or associated with the dispatch circuit and configured to redirect selected ones of the dispatched instructions to a secondary buffer of the MPC rather than the reservation queue, in dependence on a ranking of the two or more parallel instruction threads. A ranking circuit of the MPC is configured to determine the ranking as a function of respective utilization efficiencies of the two or more parallel instruction threads with respect to the reservation queue.

In another example embodiment, a method performed by a microprocessor comprising an MPC comprises dispatching instructions from two or more parallel instruction threads in program order, towards a reservation queue of the MPC. The reservation queue is used to queue dispatched instructions for issuance to a functional circuit of the MPC according to an out-of-order issuance scheduling, and the method further comprises redirecting selected ones of the dispatched instructions to a secondary buffer of the MPC rather than the reservation queue, in dependence on a ranking of the two or more parallel instruction threads. Correspondingly, the method includes determining the ranking as a function of respective utilization efficiencies of the two or more parallel instruction threads with respect to the reservation queue.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a microprocessor in an example embodiment.

FIG. 2 is a block diagram of example details for a microprocessor.

FIG. 3 is a block diagram of further example details for a microprocessor.

FIG. 4 is a diagram of an example arrangement of register tables in a microprocessor, for architectural and physical registers.

FIGS. 5 and 6 are block diagrams of an example arrangement for determining a reference age as a middle sequence number in a reorder buffer (ROB) of a microprocessor.

FIGS. 7 and 8 are block diagrams of an example arrangement for using a reference age to determine or otherwise adjust the faster/slower rankings of two instruction threads.

FIG. 9 is a block diagram of a first-in-first-out (FIFO) implementation of a secondary buffer within a multi-threaded pipeline circuit (MPC) of a microprocessor, according to an example embodiment.

FIG. 10 is a block diagram of a reservation queue according to an example embodiment, where the reservation queue is a shared resource of interest with respect to two or more instruction threads processed by an MPC.

FIG. 11 is a logic flow diagram of a method performed by a microprocessor having an MPC, according to an example embodiment.

### DETAILED DESCRIPTION

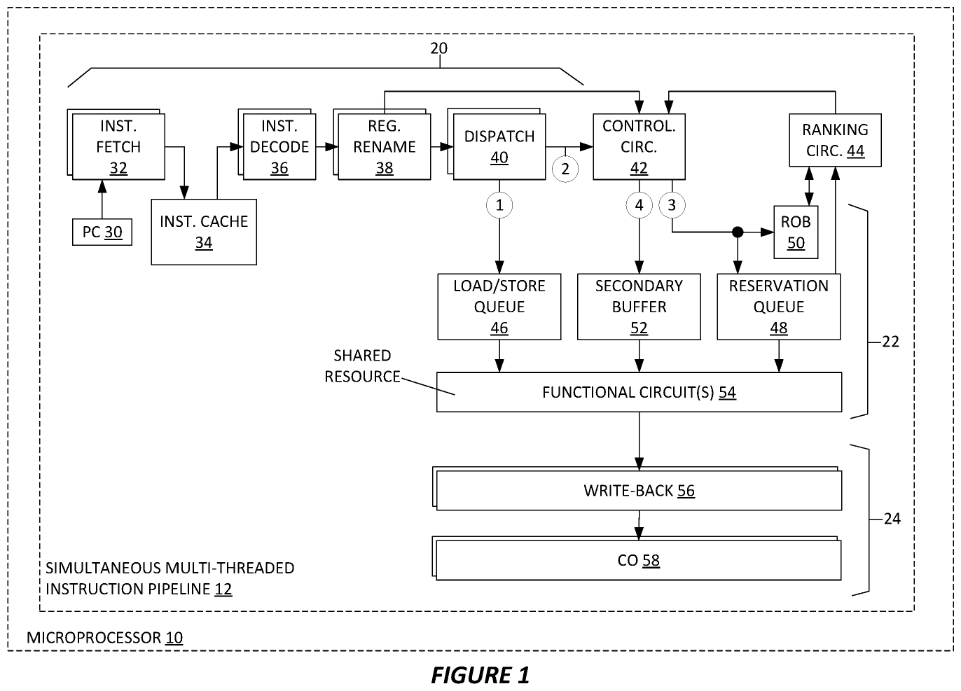

FIG. 1 illustrates an example embodiment, wherein a microprocessor 10 includes a simultaneous multi-threading (SMT) instruction pipeline 12, referred to for convenience as a multithreaded pipeline circuit 12 or simply “MPC 12”. At least functionally, the MPC 12 includes an in-order front-end portion 20, an out-of-order scheduler portion 22, and in-order back-end portion 24.

Front-end circuitry includes a program counter 30 operative to maintain a pointer indicating the current location of program execution within the program sequence, an instruction fetcher 32 that fetches instructions from an external cache or other memory into an instruction cache 34, for processing in the MPC 12. Additional front-end circuitry in the example embodiment includes an instruction decoder 36, a register renaming circuit 38, and a dispatch circuit 40.

The instruction decoder 36 is configured to decode individual instructions into their component parts, e.g., “micro” operations understood by the MPC 12, and the register renaming circuit 38 is configured to maintain associations between logical register names used by the incoming program instructions and underlying physical registers of microprocessor 10, to avoid false data dependencies between independent instructions that use the same logical registers. The dispatch circuit 40 is configured to dispatch instructions to a control circuit 42 that cooperates with a ranking circuit 44 to avoid resource monopolization problems, wherein one or more of the instructions threads being simultaneously processed by the MPC 12 is “slower” than one or more other ones of the threads and begins dominating resource usage within the MPC 12, e.g., its “occupancy” of one or more shared resources within the MPC 12 becomes out of balance with respect to the other threads.

In more detail, the dispatch circuit 40 dispatches load/store instructions to a load/store queue 46 included in the out-of-order scheduler portion 22. An encircled “1” in the diagram designates the flow of load/store instructions from the dispatch circuit 40 to the load/store queue 46, while an encircled “2” denotes the flow of all other types of instructions from the dispatch circuit 40 to the control circuit 42. In turn, the control circuit 42 sends some instructions it receives from the dispatch circuit 40 to a reservation queue 48 and reorder buffer 50 of the out-of-order scheduler portion 22, with these instructions denoted by an encircled “3” in the diagram. Selected ones of the instructions received by the control circuit 42 are, however, “redirected” to a secondary buffer 52, where the secondary buffer 52 is “secondary” with respect to the reservation queue 48. An encircled “4” in the diagram denotes the redirected instructions.

In an example embodiment, the reservation queue 48 is an instruction queue or other “complex” buffer and the secondary buffer 52 is a first-in-first-out (FIFO) buffer or other “simple” buffer, where “simple” and “complex” are relative terms and mean that the secondary buffer 52 is less complex and/or lower power in terms of its structure and operation than the reservation queue 48. Redirecting selected instructions to the secondary buffer 52 rather than to the reservation queue 48 prevents the redirected instructions from taking up room in the reservation queue 48. Note that in one or more embodiments, the control circuit 42 performs redirection on a conditional basis, i.e., it redirects selected instructions while a defined condition is satisfied and otherwise does not perform redirection. In one or more other embodiments, the control circuit 42 performs redirection unconditionally, at least for one or more types of instructions.

The out-of-order scheduler portion 22 of the MPC 12 further includes one or more functional circuits 54, such as instruction-execution units, that are issued from the reservation queue 48 and the secondary buffer 52, based on their readiness for execution. The in-order back-end portion 24 of the MPC 12 includes a write-back circuit 56 and a commit-state (CO) circuit 58, for release of resources.

Of particular interest according to at least one embodiment, the dispatch circuit 40 is configured to dispatch instructions from two or more parallel instruction threads in program order, towards the reservation queue 48, which is used to queue dispatched instructions for issuance to a functional circuit 54 according to an out-of-order issuance scheduling. Further, the control circuit 42 is configured to redirect selected ones of the dispatched instructions to the secondary buffer 52 rather than the reservation queue 48, in dependence on a ranking of the two or more parallel instruction threads. Correspondingly, the ranking circuit 44 is configured to determine the ranking as a function of respective utilization efficiencies of the two or more parallel instruction threads with respect to the reservation queue 48.

As noted, the control circuit 42 in one or more embodiments performs redirection on a conditional basis—i.e., it performs redirection of selected instructions to the secondary buffer 52, such that the redirected instructions bypass the reservation queue 48, when a defined condition is satisfied and otherwise does not perform redirection. The defined condition is, for example, an imbalance of occupancy in the reservation queue 48 by instructions from one thread versus the other threads. The imbalance—excess occupancy—may be detected by comparing the count of instructions in the reservation queue 48 for one thread versus respective ones of the other threads, and imbalance detection may use a threshold, e.g., to detect when imbalance exceeds a defined amount.

The control circuit 42 in at least one embodiment is configured to perform redirection on a conditional basis, such that redirecting is performed if a defined condition is satisfied and otherwise is not performed, and wherein, while the defined condition is satisfied, the control circuit is configured to redirect selected instructions from at least a lowest-ranked one of the two parallel instruction threads. For example, the MPC 12 is configured to support at least three parallel instruction threads, and the control circuit 42 is configured to redirect selected instructions from two or more lower-ranked ones of the at least three parallel instruction threads.

In one or more embodiments, the control circuit 42 is configured to redirect instructions of a certain type. In at least one such embodiment, the control circuit 42 is configured to receive indications from one or more register renaming circuits—e.g., the register renaming circuit 38—of the MPC 12, the indications identifying which instructions are of the certain type. The certain type of instructions is instructions that are directly dependent on memory reads, referred to as DDMR instructions.

The reservation queue 48 comprises, for example, an instruction queue configured for scheduling execution of instructions from the two or more parallel instruction threads, where the instruction queue supports out-of-order instruction execution. As a further example, the secondary buffer 52 comprises a FIFO buffer, wherein the FIFO buffer is a per-thread FIFO buffer or a FIFO buffer that is common to the two or more parallel instruction threads. Note that the common-buffer approach to the secondary buffer 52—i.e., an approach where the secondary buffer 52 holds redirected instructions from more than one instruction thread—applies to embodiments of the control circuit 42 in which the control circuit 42 performs selective redirection from two or more lower/lowest-ranked ones of the multiple instruction threads being simultaneously processed in the MPC 12.

The ranking circuit 44 in at least one embodiment is configured to maintain a rank counter corresponding to each instruction thread among the two or more parallel instruction threads and for each instruction thread (a) increment the corresponding rank counter upon issuing an instruction that belongs to the instruction thread from the reservation queue 48, if the issued instruction is younger than a reference age of instructions currently held in the reservation queue 48 and (b) decrement the corresponding rank counter if the issued instruction is older than the reference age. Based on these operations, the ranking circuit 44 ranks the two or more parallel instruction threads in dependence on the values of the corresponding rank counters, such that a higher value represents a higher ranking than a lower value.

The reorder buffer 50 of the MPC 12 contains the same instructions currently held in the reservation queue 48 in program order, as indicated by sequence numbers assigned to the instructions. In at least one embodiment, the ranking circuit 44 determines the age of any given instruction issuing from the reservation queue 48 by comparing the sequence number of the issuing instruction to one of the sequence numbers selected as the reference age. For example, the ranking circuit 44 is configured to select a middle sequence number as the reference age, and is configured to identify the middle sequence number by identifying the largest and smallest sequence numbers for the instructions currently held in the reservation queue 48. In at least one such embodiment, the MPC 12 is configured to use a common set of sequence numbers for sequentially numbering instructions from the two or more parallel instruction threads, such that the largest and smallest sequence numbers are global with respect to the two or more parallel instruction threads.

The ranking circuit 44 in at least one embodiment is configured to update the ranking of the two or more parallel instruction threads based on determining a relative age of each instruction issuing from the reservation queue 48, where an issuing instruction that is relatively younger than a reference age of the instructions currently held in the reservation queue increases a ranking value of the corresponding instruction thread, and where an issuing instruction that is relatively older than the reference age decreases the ranking value of the corresponding instruction thread.

In another embodiment, the ranking circuit 44 is configured to rank the two or more parallel instruction threads based on comparing the number of instructions currently held in the reservation queue 48 for each instruction thread, such that a first one of the two or more parallel instruction threads having a lesser number of instructions currently held in the reservation queue 48 has a higher ranking than a second one of the two or more parallel instruction threads that has a greater number of instructions currently held in the reservation queue 48. As another example, for ranking the two or more parallel instruction threads, the ranking circuit 44 is configured to identify the lowest-ranked one of the two or more parallel instruction threads as the instruction thread having the greatest number of instructions currently held in the reservation queue 48.

In other embodiments of the ranking circuit 44, the ranking circuit 44 uses a combination of ranking techniques to determine the relative rankings of instructions threads, using either equal weighting or unequal weighting among the ranking techniques. For example, the ranking circuit 44 determines the relative rankings of the instructions threads being processed in the MPC 12 based on considering the ages of instructions issuing from the reservation queue 48 on a per-thread basis and also based on the number of instructions in the reservation queue 48 on a per-thread basis. Whether the ranking circuit 44 uses a single ranking technique or ranks the threads based on a combination of two or more ranking techniques, its ranking operations are based on the respective utilization efficiencies of the two or more parallel instruction threads with respect to the reservation queue 48.

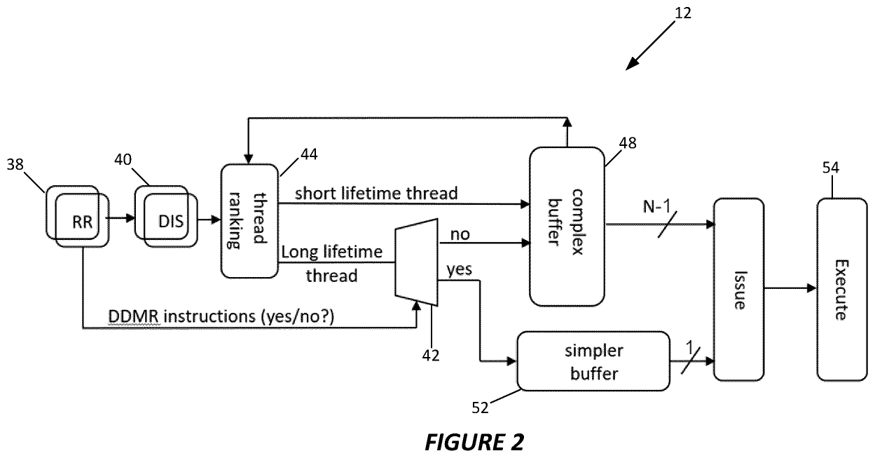

FIG. 2 offers a functional depiction of the MPC 12 in one embodiment, with the example operations depicted for a case where there are two parallel instructions threads being handled by the MPC 12. The register renaming (RR) circuitry 38 provides indications to the control circuit 42 of instructions that are of the DDMR type. These indications may be done only for the lowest-ranked one or lowest-ranked ones of the instructions threads or may be provided for all instruction threads, although the indications may be segregated on a per-thread basis.

The ranking circuit 44 receives all instructions for the two threads (except possibly load/store instructions, which may be sent to the load/store queue 46) from the dispatch circuit 40. The lowest-ranked thread of the two threads being handled is shown as a “long lifetime thread” to denote the longer occupancy times of its instructions in the reservation queue 48. Consequently, FIG. 2 labels the remaining, faster thread as the “short lifetime thread”. The ranking circuit 44 sends the instructions for the longer lifetime thread to the control circuit 42 and the control circuit 42 redirects selected instructions from the longer lifetime thread to the secondary buffer 52, shown in FIG. 2 as a “simpler buffer” to denote its lower complexity with respect to the reservation queue 48, which is shown as a “complex buffer”.

Specifically, with respect to the instructions of the long lifetime thread, the control circuit 42 redirects DDMR instructions to the secondary buffer 52 such that that type of instruction bypasses the reservation queue 48; the control circuit 42 passes the remaining types of instructions in the long lifetime thread to the reservation queue 48 as would normally happen. Indications flowing from the register renaming circuitry 38 enable the control circuit 42 to identify which ones of the instructions in the long lifetime thread are DDMR instructions.

In other details of FIG. 2, the functional circuit 54 is shown as an execution unit. Instructions issuing from the reservation queue 48 and the secondary buffer 52 are executed in the functional circuit 54.

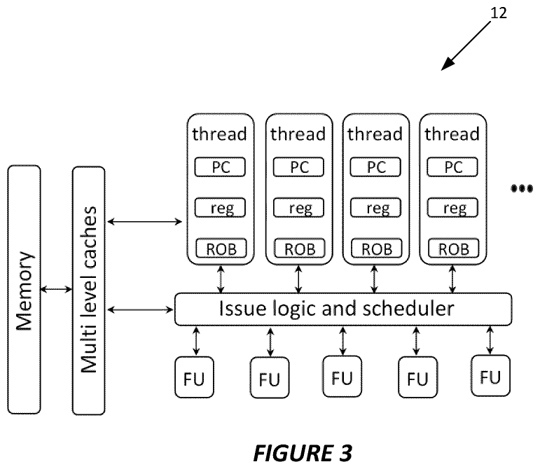

Here and elsewhere in the MPC 12, the various circuits shown may comprise parallel instantiations of circuitry, for handling the two or more instruction threads. FIG. 3 illustrates such details according to an example embodiment. Memory and multilevel memory caches feed instructions from two or more threads into circuitry functioning as issue logic and a scheduler, where the MPC 12 supports each instruction thread with a respect program counter (PC), reorder buffer (ROB), and registers (reg), and where there are multiple functional units, e.g., execution units. In the context of FIG. 3, the control circuit 42 and ranking circuit 44 may be incorporated into the issue logic and scheduler.

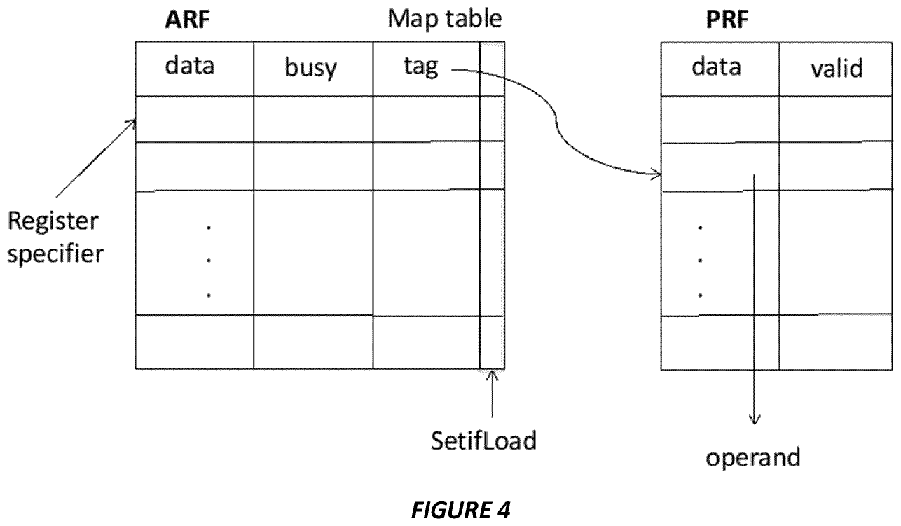

FIG. 4 illustrates an example approach to identifying “slow instructions” in one or more embodiments of the microprocessor 10 and its included MPC 12. While the contemplated approach may identify more than one type of instruction as being a “slow” instruction in comparison to other types of instructions, details presented here focus on DDMR instructions, with DDMR instructions being one category of the instructions that occupy the reservation queue 48 or other shared resources within the MPC 12 for a long time and cause a monopoly problem.

DDMR instructions may be identified using available pipeline information. For example, the MPC 12 includes two sets of out-of-order registers, with one set referred to as the Architectural Register File or ARF and the other set referred to as the Physical Register File or PRF. Register renaming operations involve identifying dependencies between instructions. Essentially in this stage, producers and consumers are determined. Adding storage for a “SetifLoad” indicator imposes very little additional overhead on the register structure used in modern microprocessors and it enables the MPC 12 to identify a class of instructions that predominantly negate the cost- and performance-effectiveness of out-of-order queuing and instructions scheduling.

Here, the MPC 12 sets the SetifLoad bit for a register when its writer is a load instruction. All information relied upon here, including identifying the load instructions and determining when a destination register is renamed, represents information readily available in multithreading instructions pipelines. As for DDMR instructions, which are instructions that are directly dependent on a memory read instruction (a load). At the operand reading phase of register renaming for a current instruction, if the SetifLoad bit of any of the operands is set, the current instruction that is being renamed is a DDMR instruction because one of its direct producers is a load instruction.

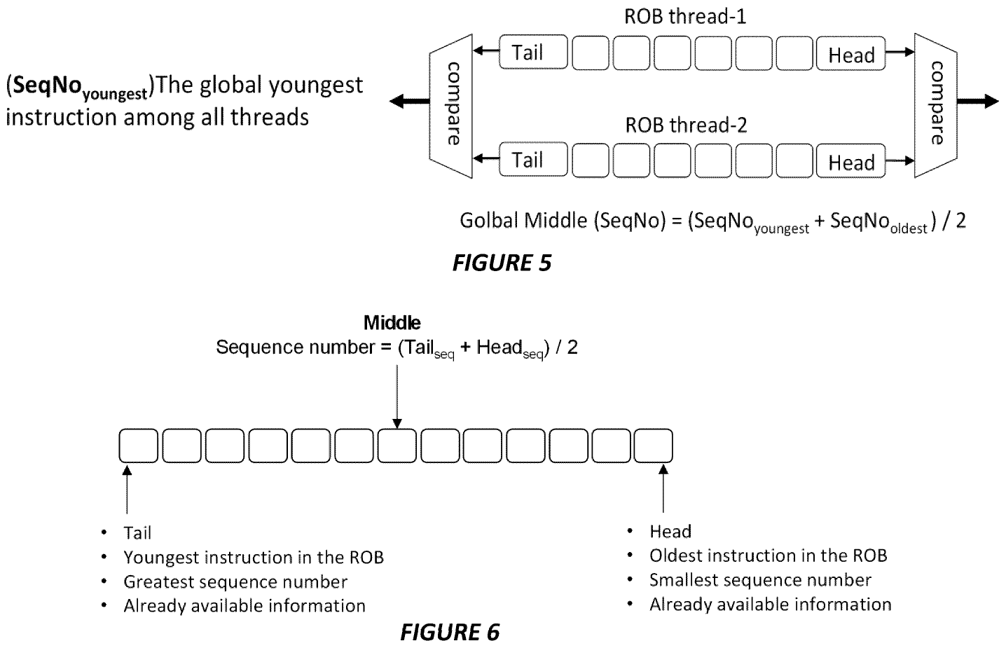

FIG. 5 illustrates a mechanism for ranking two threads involved in simultaneous processing by the MPC 12, with the understanding that the operations may be extended to more than three instruction threads. Here, ranking depends on instruction “lifetime” in the reservation queue 48 or other shared resource within the MPC 12 and exploits readily available scheduling information in the MPC 12.

Thread ranking in this example includes two phases. First, the ranking circuit 44 or other entity within the MPC 12 determines a global order of instructions among all threads, specifically the global middle sequence number. Second, the ranking circuit 44 or other entity within the MPC 12 applies the global middle sequence number to rank the threads based on their lifetimes.

Identifying the global-middle sequence number comprises, for example, comparing the sequence numbers of all “head” instructions from all threads. Comparing the sequence numbers of the head instructions of all threads results in finding the smallest sequence number among the sequence numbers of all head instructions, which is the oldest instruction among all instructions in the pipeline. The same process is applied on tail instructions; however, performing the sequence-number comparison on the tail instructions across all threads results in identifying the greatest sequence number in the ROB, i.e., the global tail. Having the global tail and head makes it effortless to identify the global middle sequence number. The tail instruction having the greatest sequence number is the “youngest” (newest) instruction in the ROB.

FIG. 6 illustrates the above processing, by showing all instructions in the ROB arranged left-to-right from the sequence number corresponding to the global-tail instruction to the sequence number corresponding to the global-head instruction. The middle sequence number may then be determined and used, for example, to determine whether any given instruction issuing from the reservation queue 48 to the functional circuit 54 is “younger” or “older” than the instruction corresponding to the middle sequence number. Such determinations then feed into thread ranking according to one or more embodiments.

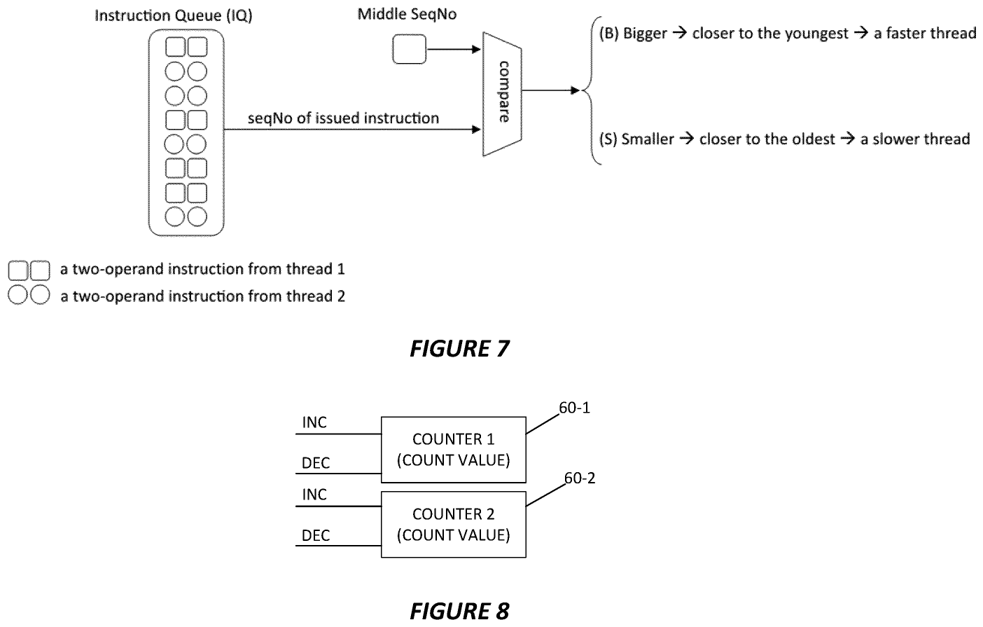

FIG. 7 illustrates application of age-based ranking of instruction threads according to one embodiment, in each instruction cycle. When an instruction is issued for execution, two pieces of information are already available, its sequence number and its thread identifier (ID). Comparing the sequence number of the issuing instruction to the global “middle” sequence number provides a basis for determining whether the instruction thread to which the issuing instruction belongs is a “faster” thread or a “slower” thread. Note that the faster/slower determination is a trend-wise or incremental determination, with the faster/slower characteristic of each thread determined over multiple instruction cycles, based on whether the instructions issued from each thread tend to be younger than or older than the reference age for instructions. The reference age is, for example, defined by the global middle sequence number of sequence numbers in the ROB.

With this approach, the ranking circuit 44 maintains a counter for each one of the instruction threads. See FIG. 8, showing an example implementation for a two-thread scenario, where the ranking circuit 44 maintains a counter 60-1 for a first one of two instruction threads and a counter 60-2 for a second one of the two instruction threads. In an example scenario, each time an instruction for the first thread issues from the reservation queue 48, the count value in the counter 60-1 is incremented or decremented in dependence on whether the issuing instruction is older than (increment count value) or younger than (decrement count value) the reference age. The same operations and logic apply for the counter 60-2, which maintains a like count value for the second thread.

With this approach, in any given instruction cycle, the ranking circuit 44 ranks the two instruction threads in dependence on their respective count values. That is, if one of the threads has a higher count value than the other thread, that thread is “slower” than the other thread and has a lower rank than the other thread. The count-based approach reflects “historical” thread performance in that the count values change over successive instruction cycles and reflect prevailing trends in terms of which thread(s) are faster or slower in a relative sense.

In turn, the control circuit 42 may redirect certain instructions from the lower-ranked thread, such that they are buffered in the secondary buffer 52 rather than buffered in the reservation queue 48. These certain instructions are DDMR instructions and/or one or more other types of instructions that are characteristically slower or longer-latency instructions. The redirection may be conditional, such as where the control circuit 42 performs redirection only when the difference in count values between the two threads exceeds a defined difference. In such embodiments, the control circuit 42 may terminate redirection when the count difference falls back below the defined difference or below a somewhat smaller difference, to impose a certain level of hysteresis on the change from redirection to no redirection.

Redirecting DDMR or other slow types of instructions from the lower-ranked thread(s) results in both dynamic and static energy savings, at least in cases where the secondary buffer 52 is less complex/lower power than the reservation queue 48. For example, regarding the reduction of dynamic energy, dispatching DDMR instructions to the secondary buffer 52 is equivalent to a “write” operation because writing into a FIFO or other simple structure is cheaper than putting the instruction into the reservation queue 48, which may be an instruction queue operating as Content Addressable Memory (CAM). Similarly, issuing DDMR instructions from the secondary buffer 52 is equivalent to a “read” operation. Thus, issuing DDMR instructions from the secondary buffer 52 instead of from the reservation queue 48 reduces “reads” from the reservation queue 48 and correspondingly reduces the total dynamic energy required by the MPC 12. As for reducing the static energy, buffering instructions in the secondary buffer 52 consumes less power than would be required to buffer them in the reservation queue.

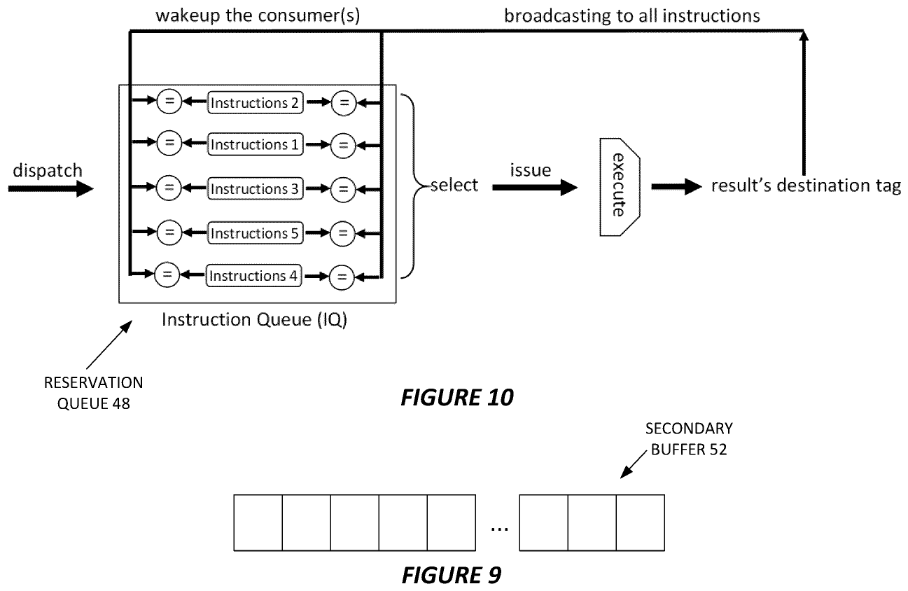

Further gains in energy efficiency apply in at least some embodiments. For example, redirection by the control circuit 42 allows the reservation queue 48 to have a reduced width and depth as compared to what would be required if it was obligated to hold the redirected instructions in addition to those instructions that were not redirected. That is, the secondary buffer 52 can be viewed as relieving at least some of the storage requirements that would otherwise be imposed on the reservation queue 48. FIG. 9 illustrates one example of the secondary buffer 52 organized as a simple FIFO buffer.

Consider a case where the reservation queue 48 is an instruction queue. Correspondingly, “wakeup” energy is reduced in the MPC 12 because the wakeup signal is now broadcasted to fewer entries compared to a conventional instruction queue. See FIG. 10 for an example “wakeup” signal distribution within an instruction-queue arrangement of the reservation queue 48. At each instruction, all the instructions held in the instruction queue (“entries”) are explored to find and select a few among the ones that are ready for issuance and execution. With a reduced instruction-queue depth, fewer instructions need be explored (evaluated) at each instruction cycle, with less complex mesh connections within the instruction queue and, therefore, reduced power consumption.

In other aspects of improved energy efficiency, reducing instruction-queue width results in issuing fewer instructions from the instruction queue, which reduces the number of instructions that are selected for issuance at each cycle. A typical modern processor issues four to six instructions per cycle. Reducing the issue width by one accordingly reduces sixteen or twenty-five percent of select-and-issue hardware complexity. Such hardware reductions reduce power consumption of the instruction queue.

Referring back to FIG. 2, when given instructions from the involved threads reach the dispatch stage, the MPC 12 may already have lifetime-based rankings of the threads available and knowledge of which instructions are DDMR instructions. Correspondingly, the MPC 12 gives lower priority to the slowest/slow threads when it comes to instruction placement in the reservation queue 48 and/or any other shared resource of interest within the MPC 12.

In one or more embodiments, DDMR instructions of the slow thread(s) bypass the reservation queue 48 and instead are placed into the secondary buffer 52. Bypassing reduces the number of writes to the reservation queue 48. From an implementation point of view, each thread can have a private secondary buffer 52, or one secondary buffer 52 can be shared between all the threads subjected to redirection control by the control circuit 42. In either case, the benefit comes from bypassing the reservation queue 48 for the DDMR instructions and/or one or more other certain types of instructions. Offloading the DDMR instructions of the slow thread(s) from the reservation queue 48, provides the opportunity for instructions from the faster thread(s) to occupy reservation queue 48 and improve both thread-level and instruction-level parallelism. With this arrangement, redirected instructions are issued from the secondary buffer 52 rather than from the reservation queue 48. When an instruction reaches the head of secondary buffer 52, the control circuit 42 or another entity in the MPC 12 determines whether the instruction's operands are ready; if so, the instruction issues and, if not, the instruction is held.

The baseline issue width, therefore, is distributed between the reservation queue 48 and the secondary buffer 52, rather than being provided solely via the more complex and expensive circuitry of the reservation queue 48. As such, the combined use of the secondary buffer 52 and the reservation queue 48 allows for a smaller and reduced-power implementation of the reservation queue 48 while still offering performance/throughput equal to a conventional implementation of the pipeline without redirection and a correspondingly larger/wider implementation of the reservation queue.

In practice, if a conventional processor issues N instructions from an instruction queue at each cycle, one or more embodiments of the technique proposed herein would issue N−1 instructions from the instruction queue. If each thread has its own private secondary buffer 52, potentially fewer instructions can be issued from the instruction queue, which is a key optimization of the MPC 12.

As noted earlier, during instruction scheduling, DDMR instructions have to wait for their respective load instructions to complete. In convention pipeline implementations, the waiting time is spent in an instruction queue, which may be arranged as a CAM or other complex circuit structure that is expensive in terms of physical space and/or power consumption. However, the proposed technique allows such instructions to spend their wait times in a simpler secondary buffer 52. Offloading the DDMR instructions from the instruction queue reduces the activity factor—reads and writes—of the instruction queue.

Indeed, redirecting selected instructions to the secondary buffer 52 can be understood as “offloading” those instructions from the instruction queue or other resource shared by the two or more instruction threads being simultaneously processed by the MPC 12. Offloading in this manner offers at least two nice possibilities. The MPC 12 may use a smaller/narrower instruction queue than would be needed without offloading, or the MPC 12 may be configured to process one or more additional threads in parallel without need for increasing the size/width of the instruction queue.

Various mechanisms or approaches for detecting and indicating the instructions to be redirected are contemplated herein, as detecting and redirecting monopoly-related instructions, for example, DDMR or other long latency instructions is one of the many advantages offered by the disclosed technique(s). One approach involves identifying producer-consumer dependencies, e.g., within the context of register-renaming operations, such as by setting bits that flag or otherwise identify producer/consumer dependencies.

As for thread ranking approaches, one approach ranks threads based on the principle that threads having the highest relative frequency of issued instruction being older than the medium instruction (or some other defined reference “age”) are the “slowest” threads. There are different alternative implements for such estimation. Instead of using the middle sequence number (Tailseq+Headseq)/2, one or more embodiments use a reference point which is close the head instruction. The algorithm used for counting the frequency of issued instructions being higher or lower than this reference point might add larger values (a weighted or non-uniform counting scheme) to the ranking counter of a thread, for instructions older than such a reference point. Such an embodiment would be more sensitive to threads having proportionally old instructions.

More broadly, the “counting” or other tracking mechanism used to rank threads in any given instruction cycle as being faster or slower in relative thread-to-thread comparison may not be based on uniform increments or decrements of the per-thread count values. For example, an issuing instruction that is older than the reference age by more than a defined difference or distance or other threshold may result in a larger increase in the count value for the involved thread, as compared to an issuing instruction that is closer to the reference age. For example, there may be small, medium, and large increments used to adjust the count value in dependence on how much older the issuing instruction is than the reference age, and the same magnitudes of adjustment may be used for decrementing the count value in relation to an issuing instruction that is younger than the reference age.

Additionally, or alternatively, one or more embodiments determine thread ranking based on the principle that those threads having more instructions in the reservation queue 48 or other shared resource are more likely to lead to monopoly problems. One such embodiment uses a counter per thread. Here, the counter for a given thread is incremented as instructions from that thread are added to the reservation queue 48 and is decremented when instructions from that thread are issued from the reservation queue 48. Threads having higher counter values are deemed to be “slower”. For example, the ranking circuit 44 may consider any thread having a corresponding count value above a defined threshold to be a “slow” thread. That threshold may be fixed or may be dynamic, such as where the slow threshold depends on the size of the reservation queue 48, the number of active threads, etc.

More complex approaches to thread ranking are also contemplated, where one or more such approaches may not consider a given thread as being “slow” even though the foregoing count-based mechanisms might flag the thread as slow. In at least one such embodiment, thread ranking considers the frequency of inflow from each thread. For example, the count threshold(s) used for flagging a given thread as “slow” is adapted in view of the inflow frequency across the threads. Another embodiment jointly considers per thread instruction-queue counts and lifetime-based ranking techniques. For example, thread ranking depends on counting instructions dispatched to or from the instruction queue on a per thread basis, along with tracking the aging of those instructions within the instruction queue.

As regards the secondary buffer 52, its implementation may consider several factors or design considerations. For example, in embodiments where the MPC 12 redirects instructions only from the lowest-ranked one of the threads, instructions from only one thread at a time are subject to redirection. However, in embodiments where two or more of the lowest-ranked threads are subjected to redirection, the secondary buffer 52 may comprise a common buffer shared by instructions redirected from the lowest-ranked threads. However, the common-buffer arrangement in a FIFO or other serial implementation of the secondary buffer 52 means that the head-end instruction gates/delays all instructions that are behind it. In turn, that means that a head-end instruction from one thread can stall/delay redirected instructions from the other lowest-ranked threads. Therefore, at least in implementations of the MPC 12 where there is an emphasis on single-thread performance, the secondary buffer 52 may be implemented on a per-thread basis, meaning that there will be as many secondary buffers as there are simultaneous threads subject to redirection.

An instruction issue priority scheme may be imposed in one or more embodiments that use per-thread secondary buffers. For example, a priority based on the thread lifetime ranking may be used. For example, among the per-thread secondary buffers, the one which holds the slowest thread receives the higher priority for instruction issue, and the one which holds the fastest thread receives the lowest priority. Such prioritization makes sense because the slowest thread is already slow, and the in-order intrinsic features the secondary-buffer arrangement should not make the thread even slower. The prioritization reduces or avoids starvation or deadlock situations, because the thread ranking schemes contemplated herein may be updated per cycle-by-cycle basis and the affect the instruction scheduling proactively, before any monopoly or starvation takes place.

Other points of variation involve the types or kinds of instructions subject to redirection (offloading from an instruction queue or other key shared resource). Essentially if a category of instructions does not benefit from load-store queuing, that category of instructions may be redirected from the load/store queue to a secondary storage mechanism.

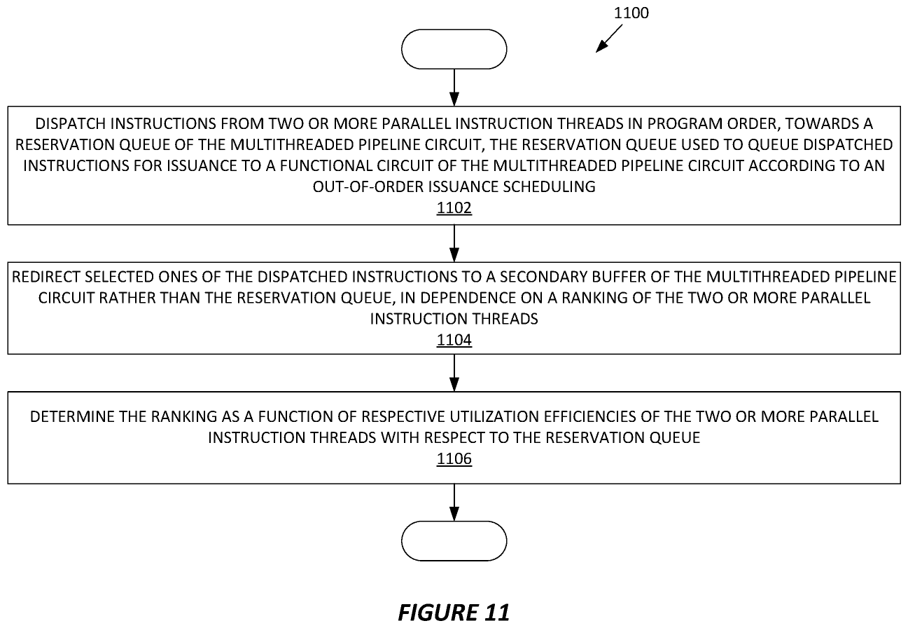

With the above embodiments in mind, FIG. 11 illustrates one embodiment of a method 1100 performed by a microprocessor 10 comprising an MPC 12. Although depicted as a sequential arrangement of steps or operations for ease of discussion, different execution orders may be used and some operations may be done in concert with others and, further, some operations may be performed in an ongoing or repeating fashion. For example, at least parts of the method 1100 may be repeated in each instruction cycle of the microprocessor 10/MPC 12.

The method 1100 includes (Block 1102) dispatching instructions from two or more parallel instruction threads in program order, towards a reservation queue 48 of the MPC 12, where the reservation queue 48 is used to queue dispatched instructions for issuance to a functional circuit 54 (or other shared resource) of the MPC 12 according to an out-of-order issuance scheduling. Further, the method 1100 includes (Block 1104) redirecting selected ones of the dispatched instructions to a secondary buffer 52 of the MPC 12 rather than the reservation queue 48, in dependence on a ranking of the two or more parallel instruction threads. Correspondingly, the method 1100 includes determining (Block 1106) the ranking as a function of respective utilization efficiencies of the two or more parallel instruction threads with respect to the reservation queue 48.

Here, the term “utilization” refers to the instruction threads making practical or effective use of the reservation queue 48, where, for example, an instruction thread whose instructions tend to wait in the reservation queue 48 longer than those of the other thread(s) being processed simultaneously via the MPC 12 may be considered as having a lower utilization efficiency of the reservation queue 48. As detailed herein, there are various approaches to quantifying (or at least qualifying on a relative basis) the utilization efficiency of the instructions threads with respect to the reservation queue, with the various techniques including, briefly, evaluating the number of instructions in the reservation queue 48 on a per-thread basis over one or more instruction cycles, to identify instances where one thread is monopolizing the reservation queue 48. Additionally, or alternatively, the utilization efficiency of each thread may be assessed by tracking (e.g., via a counter or other mechanism) the relative age of instructions exiting the reservation queue 48, on a per-thread basis. Older instructions mean that they have spent relatively more time in the queue and, hence, reflect a lower utilization efficiency.

In one example, the redirecting step 1104 is done on a conditional basis, such that redirecting is performed if a defined condition is satisfied and otherwise is not performed. While the defined condition is satisfied, the redirecting step comprises redirecting selected instructions from at least a lowest-ranked one of the two parallel instruction threads. The condition for redirection is, for example, one thread becoming slower than any of the other thread(s) by more than a defined amount or margin. Additionally, redirection in one or more embodiments is conditioned on the extent to which the shared resource in question is “full” or occupied. For example, instructions from a slow thread may not be subject to redirection if the shared resource(s) are not occupied beyond some threshold level, even if the slow thread disproportionately occupies the shared resource(s) at issue.

The MPC 12 in one or more embodiments is configured to support at least three parallel instruction threads, and, correspondingly, in at least one embodiment of the method 1100, the redirecting step 1104 comprises redirecting selected instructions from two or more lower-ranked ones of the at least three parallel instruction threads.

As noted, the redirecting step 1104 comprises, in one or more embodiments, redirecting instructions of a certain type. At least one such embodiment uses indications from one or more register renaming circuits of the MPC 12 to identify which instructions are of the certain type. As an example, the certain type of instructions is instructions that are directly dependent on memory reads, referred to as DDMR instructions. Of course, the “certain type” may be two or more types of instructions, where the term “category” is used interchangeably with “type”.

Determining the ranking in one or more embodiments comprises maintaining a rank counter 60 corresponding to each instruction thread among the two or more parallel instruction threads and for each instruction thread: (a) incrementing the corresponding rank counter 60 upon issuing an instruction that belongs to the instruction thread from the reservation queue 48, if the issued instruction is younger than a reference age of instructions currently held in the reservation queue 48, and (b) decrementing the corresponding rank counter 60 if the issued instruction is older than the reference age. On this basis, the ranking comprises ranking the two or more parallel instruction threads in dependence on the values of the corresponding rank counters, such that a higher value represents a higher ranking than a lower value. Equivalently, younger instructions trigger count decrementing and older instructions trigger count incrementing, such that a lower count value represents a higher ranking than a higher count value.

In one or more embodiments, a reorder buffer (e.g., ROB 50) of the microprocessor 10 contains the same instructions currently held in the reservation queue 48 in program order, as indicated by sequence numbers assigned to the instructions. Ranking correspondingly may include determining the age of any given instruction issuing from the reservation queue 48 by comparing the sequence number of the issuing instruction to one of the sequence numbers selected as the reference age. Ranking includes, for example, selecting a middle sequence number as the reference age and determining the middle sequence number by identifying the largest and smallest sequence numbers for the instructions currently held in the reservation queue.

Evaluating sequence numbers is more straightforward in embodiments of the microprocessor 10 that use a global/common set of sequence numbers across all instruction threads. That is, in at least one configuration of the MPC 12, it uses a common set of sequence numbers for sequentially numbering instructions from the two or more parallel instruction threads, such that the largest and smallest sequence numbers are global with respect to the two or more parallel instruction threads. If common sequence numbers are not used across the threads, the ranking scheme must account for the different sets of sequence numbers used across the different threads.

Ranking in one or more embodiments includes updating the ranking of the two or more parallel instruction threads based on determining a relative age of each instruction issuing from the reservation queue 48. An issuing instruction that is relatively younger than a reference age of the instructions currently held in the reservation queue increases a ranking value of the corresponding instruction thread, and an issuing instruction that is relatively older than the reference age decreases the ranking value of the corresponding instruction thread.

In another example, ranking comprises ranking the two or more parallel instruction threads based on comparing the number of instructions currently held in the reservation queue 48 for each instruction thread. Consequently, a first one of the two or more parallel instruction threads having a lesser number of instructions currently held in the reservation queue 48 has a higher ranking than a second one of the two or more parallel instruction threads that has a greater number of instructions currently held in the reservation queue 48. Of course, margins or threshold-differences in instruction count may be used, so that two threads having the same or similar counts within a margin are assigned the same ranking. Further, a margin or difference threshold may be defined such that the instruction redirection described herein is active for a lower-ranked thread only when its “ranking” is lower than that of the other thread(s) by more than a certain amount.

As a specific example, the ranking comprises deeming the thread among the two or more threads that has the greatest number of instructions currently held in the reservation queue 48 as the lowest-ranked thread. This approach may be modified to consider historical conditions. For example, a counter may be maintained for each instruction thread, where the counter corresponding to the instruction thread having the highest occupancy of the reservation queue in each instruction cycle is the one that is incremented. Then, the lowest-ranked thread would be the thread having the highest count value in the corresponding counter.

A lower/lowest-ranked thread may be understood as one that is causing a monopolization of one or more resources in the MPC 12, where such one or more resources are shared among the threads being simultaneously processed by the MPC 12. A monopolizing thread is “dormant” in that one or more of instructions are delayed in terms of being ready for execution, meaning that those instructions occupy the shared resource(s) for longer times in comparison to threads with better flow through the shared resource(s). Slow threads have lower ILP for example.

The technique(s) disclosed herein address the problems caused by slow threads in SMT pipeline environments proactively, e.g., by identifying slow threads based on information available within the involved instruction pipeline. In at least one embodiment, the technique involves ranking the threads every instruction cycle, from the fastest to the slowest based on their respective “lifetimes”. Here, “lifetime” denotes or relates to the number of cycles that instructions from a given thread have occupied the pipeline resources of interest, such as an instruction queue. Imposing a bypass control on at least selected instructions of a slow thread avoids the monopolization problems that would otherwise arise by allowing those instructions to occupy the shared resource at issue. That is, redirecting certain instructions from a slow thread to a simpler resource, such as a simple FIFO rather than an instruction queue, prevents those instructions from causing resource monopolization in the shared resource. Bypassing gives more space to other threads in the shared resource(s) and improves the system throughput and can be done without hurting the single-thread performance. It also reduces the activity factor (number of reads and writes) of the shared resources which improves energy efficiency.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-28. (canceled)

29. A microprocessor comprising a multithreaded pipeline circuit comprising:
a dispatch circuit configured to dispatch instructions from two or more parallel instruction threads in program order, towards a reservation queue used to queue dispatched instructions for issuance to a functional circuit according to an out-of-order issuance scheduling;
a control circuit included in or associated with the dispatch circuit and configured to redirect selected ones of the dispatched instructions to a secondary buffer rather than the reservation queue, in dependence on a ranking of the two or more parallel instruction threads; and
a ranking circuit configured to determine the ranking as a function of respective utilization efficiencies of the two or more parallel instruction threads with respect to the reservation queue.

30. The microprocessor of claim 29, wherein the control circuit is configured to perform redirection on a conditional basis, such that redirecting is performed if a defined condition is satisfied and otherwise is not performed, and wherein, while the defined condition is satisfied, the control circuit is configured to redirect selected instructions from at least a lowest-ranked one of the two parallel instruction threads.

31. The microprocessor of claim 29, wherein the multithreaded pipeline circuit is configured to support at least three parallel instruction threads, and wherein the control circuit is configured to redirect selected instructions from two or more lower-ranked ones of the at least three parallel instruction threads.

32. The microprocessor of claim 29, wherein the reservation queue comprises an instruction queue configured for scheduling execution of instructions from the two or more parallel instruction threads, the instruction queue supporting out-of-order instruction execution.

33. The microprocessor of claim 29, wherein the secondary buffer comprises a First-In-First-Out (FIFO) buffer, wherein the FIFO buffer is a per-thread FIFO buffer or a FIFO buffer that is common to the two or more parallel instruction threads.

34. The microprocessor of claim 29, wherein the control circuit is configured to redirect instructions of a certain type.

35. The microprocessor of claim 34, wherein the control circuit is configured to receive indications from one or more register renaming circuits of the multithreaded pipeline circuit, the indications identifying which instructions are of the certain type.

36. The microprocessor of claim 34, wherein the certain type of instructions is instructions that are directly dependent on memory reads, referred to as DDMR instructions.

37. The microprocessor of claim 29, wherein, to determine the ranking, the ranking circuit is configured to:
maintain a rank counter corresponding to each instruction thread among the two or more parallel instruction threads and for each instruction thread:
increment the corresponding rank counter upon issuing an instruction that belongs to the instruction thread from the reservation queue, if the issued instruction is younger than a reference age of instructions currently held in the reservation queue; and
decrement the corresponding rank counter if the issued instruction is older than the reference age; and
rank the two or more parallel instruction threads in dependence on the values of the corresponding rank counters, such that a higher value represents a higher ranking than a lower value.

38. The microprocessor of claim 37, wherein a reorder buffer of the microprocessor contains instructions currently held in program order in a dynamic instruction window used by the multithreaded pipeline circuit, the program order indicated by sequence numbers assigned to the instructions, and wherein the ranking circuit determines the age of any given instruction issuing from the reservation queue by comparing the sequence number of the issuing instruction to one of the sequence numbers selected as the reference age.

39. The microprocessor of claim 38, wherein the ranking circuit is configured to select a middle sequence number as the reference age, and is configured to identify the middle sequence number by identifying the largest and smallest sequence numbers for the instructions currently held in the reservation queue.

40. The microprocessor of claim 38, wherein the multithreaded pipeline circuit is configured to use a common set of sequence numbers for sequentially numbering instructions from the two or more parallel instruction threads, such that the largest and smallest sequence numbers are global with respect to the two or more parallel instruction threads.

41. The microprocessor of claim 29, wherein the ranking circuit is configured to update the ranking of the two or more parallel instruction threads based on determining a relative age of each instruction issuing from the reservation queue, wherein an issuing instruction that is relatively younger than a reference age of the instructions currently held in the reservation queue increases a ranking value of the corresponding instruction thread, and wherein an issuing instruction that is relatively older than the reference age decreases the ranking value of the corresponding instruction thread.

42. The microprocessor of claim 29, wherein the ranking circuit is configured to rank the two or more parallel instruction threads based on comparing the number of instructions currently held in the reservation queue for each instruction thread, such that a first one of the two or more parallel instruction threads having a lesser number of instructions currently held in the reservation queue has a higher ranking than a second one of the two or more parallel instruction threads that has a greater number of instructions currently held in the reservation queue.

43. The microprocessor of claim 29, wherein, for ranking the two or more parallel instruction threads, the ranking circuit is configured to identify the lowest-ranked one of the two or more parallel instruction threads as the instruction thread having the greatest number of instructions currently held in the reservation queue.

44. A method performed by a microprocessor comprising a multithreaded pipeline circuit, the method comprising:
dispatching instructions from two or more parallel instruction threads in program order, towards a reservation queue of the multithreaded pipeline circuit, the reservation queue used to queue dispatched instructions for issuance to a functional circuit of the multithreaded pipeline circuit according to an out-of-order issuance scheduling;
redirecting selected ones of the dispatched instructions to a secondary buffer of the multithreaded pipeline circuit rather than the reservation queue, in dependence on a ranking of the two or more parallel instruction threads; and
determining the ranking as a function of respective utilization efficiencies of the two or more parallel instruction threads with respect to the reservation queue.

45. The method of claim 44, wherein the redirecting step is done on a conditional basis, such that redirecting is performed if a defined condition is satisfied and otherwise is not performed, and wherein, while the defined condition is satisfied, the redirecting step comprises redirecting selected instructions from at least a lowest-ranked one of the two parallel instruction threads.

46. The method of claim 44, wherein the multithreaded pipeline circuit is configured to support at least three parallel instruction threads, and wherein the redirecting step comprises redirecting selected instructions from two or more lower-ranked ones of the at least three parallel instruction threads.

47. The method of claim 44, wherein the redirecting step comprises redirecting instructions of a certain type.

48. The method of claim 47, further comprising using indications from one or more register renaming circuits of the multithreaded pipeline circuit to identify which instructions are of the certain type.

49. The method of claim 47, wherein the certain type of instructions is instructions that are directly dependent on memory reads, referred to as DDMR instructions.

50. The method of claim 44, wherein determining the ranking comprises:
maintaining a rank counter corresponding to each instruction thread among the two or more parallel instruction threads and for each instruction thread:
incrementing the corresponding rank counter upon issuing an instruction that belongs to the instruction thread from the reservation queue, if the issued instruction is younger than a reference age of instructions currently held in the reservation queue; and
decrementing the corresponding rank counter if the issued instruction is older than the reference age; and
ranking the two or more parallel instruction threads in dependence on the values of the corresponding rank counters, such that a higher value represents a higher ranking than a lower value.

51. The method of claim 50, wherein a reorder buffer of the microprocessor contains instructions currently held in program order in a dynamic instruction window used by the multithreaded pipeline circuit, the program order indicated by sequence numbers assigned to the instructions, and wherein the ranking includes determining the age of any given instruction issuing from the reservation queue by comparing the sequence number of the issuing instruction to one of the sequence numbers selected as the reference age.

52. The method of claim 51, wherein the ranking includes selecting a middle sequence number as the reference age and determining the middle sequence number by identifying the largest and smallest sequence numbers for the instructions currently held in the reservation queue.

53. The method of claim 51, wherein the multithreaded pipeline circuit is configured to use a common set of sequence numbers for sequentially numbering instructions from the two or more parallel instruction threads, such that the largest and smallest sequence numbers are global with respect to the two or more parallel instruction threads.

54. The method of claim 44, wherein the ranking includes updating the ranking of the two or more parallel instruction threads based on determining a relative age of each instruction issuing from the reservation queue, wherein an issuing instruction that is relatively younger than a reference age of the instructions currently held in the reservation queue increases a ranking value of the corresponding instruction thread, and wherein an issuing instruction that is relatively older than the reference age decreases the ranking value of the corresponding instruction thread.
